(19) United States
(12) Patent Application Publication
(10) Pub. No.: US 2003/0063893 A1
(43) Pub. Date: Apr. 3, 2003

(54) Faster channel change with PVR pause capability

(76) Inventor: Christopher Jensen Read, San Diego, CA (US)

Correspondence Address: MILLER PATENT SERVICES, 2500 DOCKERY LANE, RALEIGH, NC, 27606, US

(21) Appl. No.: 09/970,359

(22) Filed: Oct. 3, 2001

(51) Int. Cl. H04N 5/76; H04N 5/781

(52) U.S. Cl. 386/46; 386/125

(57) ABSTRACT

A method and apparatus for rapid channel change in a personal video recorder (PVR). Immediately after a channel change command is received, the PVR directs video directly to its output for display on a television display, bypassing the normal process of storing the video to the hard disk drive and then retrieving the video for display. This permits channel change speed to be limited only by the speed that a tuner's channel can be changed and not by the speed of the disk drive and associated processes for storage and retrieval of programming from the new channel. Output from the hard disk drive is used when special effects such as live pause are desired.

### FIELD OF THE INVENTION

This invention relates generally to the field of personal video recorders (PVR). More particularly, this invention relates to a method and apparatus for rapid channel change retaining the ability to provide live pause and other PVR effects.

### BACKGROUND OF THE INVENTION

Personal video recorders have recently been introduced to the marketplace by Sony Corporation, Tokyo, Japan and others. These devices use a hard disk drive (HDD) as a storage medium for a user to store television programming. Due to the random access ability of a hard disk drive, PVRs can provide the user with the ability to carry out functions never before possible. One such function is the so called “live pause” function.

When a user is viewing a live television program and instructs the PVR to pause, a frame of video is frozen on the display and the user can resume watching the live broadcast by issuing a “resume” command (generally a second activation of a “pause” button.) Such a function is made possible by the fact that the user is generally not truly watching a live broadcast, but is in fact seeing the broadcast delayed by a short amount of time. Within the PVR, the live broadcast is written to the PVR's hard disk drive and then read out in “near real time” for display to the viewer a brief time later (e.g., roughly on the order of one second). However, for all practical purposes, the viewer sees what is perceived to be a live broadcast. This is done so that when the “pause” button is activated, the PVR can instantly freeze the current frame on the display while the live broadcast is recorded to the hard disk drive. When the user “resumes”, playback proceeds from the hard disk drive while the live broadcast continues to be recorded. Thus, the user is able to take breaks in viewing a live broadcast and resume at a later time without missing any of the programming.

Such functionality does not come without a price, however. Since the viewer is always viewing the programming from the hard disk drive, there is a substantial delay in response when changing channels. The delay is caused by the need for the PVR to change channels in its internal tuner to the newly selected channel, begin recording the newly selected programming and then begin playback of the recorded programming. This slow response is an annoyance to the viewer and a source of frustration.

### SUMMARY OF THE INVENTION

The present invention relates generally to personal video recorders. Objects, advantages and features of the invention will become apparent to those skilled in the art upon consideration of the following detailed description of the invention.

In one embodiment consistent with the present invention a method and apparatus for rapid channel change in a personal video recorder (PVR) is provided. Immediately after a channel change command is received, the PVR directs video directly to its output for display on a television display, bypassing the normal process of storing the video to the hard disk drive and then retrieving the video for display. This permits channel change speed to be limited only by the speed that a tuner's channel can be changed and not by the speed of the disk drive and associated processes for storage and retrieval of programming from the new channel. Output from the hard disk drive is used when special effects such as live pause are desired.

A personal video recorder device consistent with an embodiment of the present invention has an input receiving a video signal input and producing a live video signal as an output. A disk drive stores a representation of the live video signal input as it is received by the input and provides as an output a stored video signal. An output provides a video output signal. A switch routes a signal to the output. A controller controls the switch, wherein the controller receives user commands and responsive to a user command to change a channel, commands the switch to route the live video signal to the output.

A personal video recorder device consistent with another embodiment of the invention has an input receiving a video signal input and producing a live video signal as an output. A disk drive stores a representation of the live video signal input as it is received by the input and provides as an output a stored video signal. An output provides a video output signal. A switch routes a signal to the output. A controller controls the switch, wherein the controller receives user commands and responsive to a user command to implement an effect using the disk drive, commands the switch to route the stored video signal to the output.

Another personal video recorder device consistent with an embodiment of the invention has a tuner receiving a video signal input and producing a live video signal as an output. An analog to digital converter receives the live video signal and converts it to a digital live video signal. A disk drive receives and stores the digital live video signal input as it is produced by the analog to digital converter and provides as an output a stored digital video signal. A digital to analog converter receives the stored digital video signal and produces an analog video signal. An output circuit provides an output signal suitable for display on a video display. A switch routes a signal to the output circuit. A controller directs the switch to provide one of the live video signal and the analog video signal to the output circuit. Wherein, the controller receives user commands and responsive to a user command to change a channel, commands the switch to route the live video signal to the output circuit.

Another personal video recorder device consistent with an embodiment of the invention has a tuner receiving a video signal input and producing a live video signal as an output. An analog to digital converter receives the live video signal and converts it to a digital live video signal. A disk drive receives and stores the digital live video signal input as it is produced by the analog to digital converter and providing as an output a stored digital video signal. A digital to analog converter receives the stored digital video signal and produces an analog video signal. An output circuit provides an output signal formatted for display on a video display. A switch routes a signal to the digital to analog converter. A controller directs the switch to provide one of the digital live video signal and the stored digital video signal to the digital to analog converter. Wherein, the controller receives user commands and responsive to a user command to change a channel, commands the switch to route the digital live video signal to the digital to analog converter.

Another personal video recorder device consistent with an embodiment of the invention has a tuner receiving a video signal input and producing a live video signal as an output. An analog to digital converter receives the live video signal and converts it to a digital live video signal. A disk drive receives and stores the digital live video signal input as it is produced by the analog to digital converter and provides as an output a stored digital video signal. A digital to analog converter receives the stored digital video signal and produces an analog video signal. An output circuit provides an output signal to a video display. A switch routes a signal to the digital to analog converter. A controller directs the switch to route one of the digital live video signal and the stored digital video signal to the digital to analog converter. Wherein, the controller receives user commands and responsive to a user command to implement an effect using the disk drive, the controller commands the switch to route the stored digital video signal to the digital to analog converter.

Another personal video recorder device consistent with an embodiment of the invention has an input receiving a video signal input and producing a live video signal as an output. A disk drive stores a representation of the live video signal input as it is received by the input and providing as an output a stored video signal. An output circuit that provides an output signal suitable for driving a video display. A switch routes a signal to the output circuit. A controller controls the switch. Wherein, the controller receives user commands and responsive to a user commands operates the switch in one of a live video output mode and a delayed video output mode, wherein in the delayed video output mode the switch routes a signal to the output circuit by retrieval of the stored video signal and wherein in the live video output mode the switch routes a signal to the output circuit without storage and retrieval in the disk drive.

Another personal video recorder device consistent with an embodiment of the invention has a tuner receiving a video signal input and producing a video transport stream as an output. A demultiplexer receives the transport stream and extracts a digital live video signal therefrom. A disk drive receives and stores the digital live video signal input from the demultiplexer and provides as an output a stored digital video signal. An output circuit provides an output signal suitable for display on a video display. A switch routes a signal to the output circuit. A controller directs the switch to provide one of the digital live video signal and the stored digital video signal to the output circuit. Wherein the controller receives user commands and responsive to a user command to change a channel, commands the switch to route the live digital video signal to the output circuit.

Another personal video recorder device consistent with an embodiment of the invention has a tuner receiving a video signal input and producing a video transport stream as an output. A demultiplexer receives the transport stream and extracts digital live video signal therefrom. A disk drive receives and stores the digital live video signal input from the demultiplexer and provides as an output a stored digital video signal. An output circuit provides an output signal suitable for display on a video display. A switch routes a signal to the output circuit. A controller directs the switch to provide one of the digital live video signal and the stored digital video signal to the output circuit. Wherein, the controller receives user commands and responsive to a user command to implement an effect using the disk drive, the controller commands the switch to route the stored digital video signal to the output circuit.

A method of controlling operation of a personal video recorder (PVR), consistent with an embodiment of the invention includes receiving an input signal from a video source; storing a representation of the video signal on a hard disk drive; providing a video output signal; controlling a source of the output signal by determining if a channel change command has been issued, wherein: if a channel change command has not been issued, selecting the source of the output signal to be from the hard disk drive; and if a channel change command has been issued, selecting the source of the output signal to be from a source prior to the hard disk drive so that the source of the output signal is not delayed by storage to and retrieval from the hard disk drive.

Another method of controlling operation of a personal video recorder (PVR) consistent with an embodiment of the invention includes receiving an input signal from a video source; storing a representation of the video signal on a hard disk drive; providing a video output signal; controlling a source of the output signal by determining if an effect command has been issued, wherein: if an effect command has been issued, selecting the source of the output signal to be from the hard disk drive; and if an effect command has been issued, selecting the source of the output signal to be from a source prior to the hard disk drive so that the source of the output signal is not delayed by storage to and retrieval from the hard disk drive.

Another method of controlling operation of a personal video recorder consistent with an embodiment of the invention includes at a tuner, receiving an input signal containing television programming; storing a digital representation of the television programming to a storage medium; retrieving the digital representation from the storage medium; presenting the retrieved digital representation to an output in a format suitable for display on a television display; and receiving a channel change command, and in response thereto presenting a representation of the television programming received at the tuner to the output without the storing and retrieving.

Another method of controlling operation of a personal video recorder consistent with an embodiment of the invention includes at a tuner, receiving an input signal containing television programming; storing a digital representation of the television programming to a storage medium; sending a representation of the input signal to an output formatted for display on a display as live video; and receiving an effect command, and in response thereto retrieving the digital representation from the storage medium and presenting the retrieved digital representation to the output as delayed video.

Any of the above methods can be carried out on a computer and represented as program instructions stored on any suitable electronic storage medium or transmitted over any suitable communication medium.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a simplified block diagram of a conventional PVR design.

FIG. 2 is a simplified block diagram of a PVR consistent with an embodiment of the current invention.

FIG. 3 is a simplified block diagram of a PVR consistent with another embodiment of the current invention.

FIG. 4 is a flow chart describing operation consistent with an embodiment of the current invention.

FIG. 5 is a flow chart describing operation consistent with another embodiment of the current invention.

FIG. 6 is a flow chart describing operation consistent with another embodiment of the current invention.

FIG. 7 is a simplified block diagram of a digital PVR consistent with another embodiment of the current invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

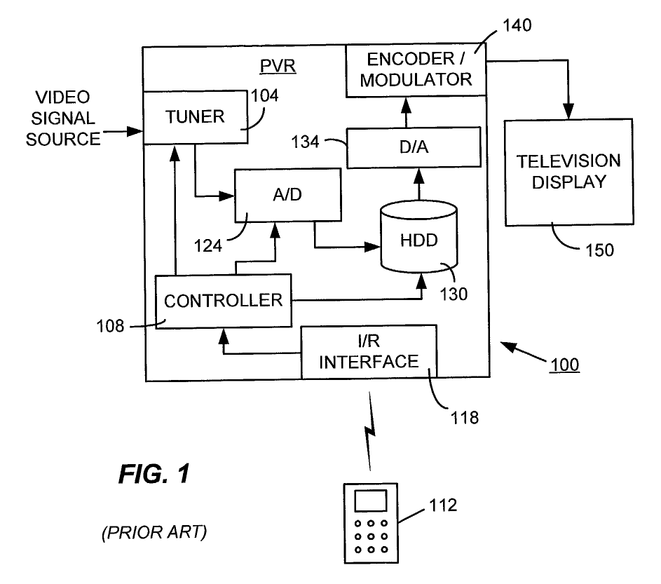

Turning now to FIG. 1, a simplified depiction of a conventional PVR 100 is illustrated in block diagram form. PVR 100 receives an input video signal from any suitable source such as a satellite receiver, a cable television system or an antenna receiving broadcast stations at a tuner 104. The tuner 104 is controlled by a controller (e.g., a microprocessor or microcontroller based controller) 108 to select a desired channel. Controller 108 receives signals from a user through a remote controller that communicates with the PVR 100 through, for example, an infrared interface 118. Those skilled in the art will appreciate that other user interfaces including but not limited to control panels and buttons forming a part of PVR 100 can also be used to effect various controls over the operation of PVR 100.

The television programming received by tuner 104 may, for example, be in the form of an RF modulated analog format such as NTSC or PAL. However, this is not to be limiting since those skilled in the art will appreciate that a PVR consistent with embodiments of the present invention (which will be illustrated with corresponding structures to PVR 100) may also be designed to directly receive satellite or digital cable broadcast signals (i.e., RF modulated MPEG or DVI format video signals) without departing from the invention. In any case, the tuner serves to mix the RF signal down to an appropriate IF or baseband signal and then demodulate the signal (either directly into a digital format using A/D converter 124, or using an analog demodulator that then provides a baseband analog signal to A/D converter 124). For illustrative purposes, it can be assumed that the video signal source provides an RF modulated NTSC or PAL format video signal without loss of generality.

The tuner selects a particular channel of programming under control of the user and provides an analog output signal representing the programming to an analog to digital converter (A/D) 124. The A/D converter 124 may incorporate a compression engine to reduce the bandwidth of the input signal and convert it to a compressed digital representation such as an MPEG (Moving Pictures Expert Group) compliant compressed digital signal. The digital representation may also be encrypted in certain realizations.

The digital representation of the signal from A/D 124 is stored in a hard disk drive 130. Disk drive 130 may be used for long term storage of the programming or short term storage of a segment of the programming for special effects. During normal television viewing, the stored digital representation of the television programming is retrieved from the HDD 130 and sent to a digital to analog converter (D/A) 134 that carries out an operation opposite that of 124 to restore an analog representation of the programming at its output. Simultaneously, live video is continuously stored in the hard disk drive 130 and retrieved a short time thereafter for playback. The analog representation from D/A 134 is presented to an encoder/modulator 140 that converts the analog representation into a form that can be received and properly displayed by television display 150 (e.g., component video, composite video, PAL or NTSC format video). Thus, the user when viewing a broadcast actually sees a delayed version of the broadcast, with the delay being largely caused by the time lag between storage in hard disk drive 130 and retrieval therefrom for display. This provides the PVR 100 with a convenient mechanism for producing special effects such as “live pause” in which the current frame of video is frozen on the display while the incoming programming (live programming) is stored for playback on the HDD 130.

When a user issues a channel change command from remote controller 112 in such a system, a delay is incurred due to the need for the controller to issue a command to the tuner 104 to change channels and the need for an initial segment of data to be converted to digital at 124, stored at HDD 130 and then retrieved from HDD 130, converted to analog and presented to the television display 150. This delay, although only on the order of a second, is dramatically slower than conventional television tuning (which is almost instantaneous) and proves to be an annoyance to users as previously described.

Those skilled in the art will appreciate that the block diagram of FIG. 1 should be considered conceptual and may not represent the physical arrangement of functional blocks in an actual PVR. However, the block diagram of PVR 100 provides a functional illustration at a high level for understanding the operation of a conventional PVR.

For purposes of this document, the term “live video” and similar terms are intended to embrace video signals that can be received and displayed on a display with minimal delay, such minimal delay being that resulting from conventional signal processing operations. These terms are used to distinguish between such “live video” and video which is first stored in a storage medium such as a disk drive and then retrieved for display. Additionally, as used herein the term “video” is to be given its conversational meaning which may include not only pure video content, but may also include audio content as well as other information. This is consistent with the term's use in, for example, in “video cassette recorder”, “personal video recorder”, “video camera”, “music video”, etc. and is thus not to be strictly limited to information representing pure visual content.

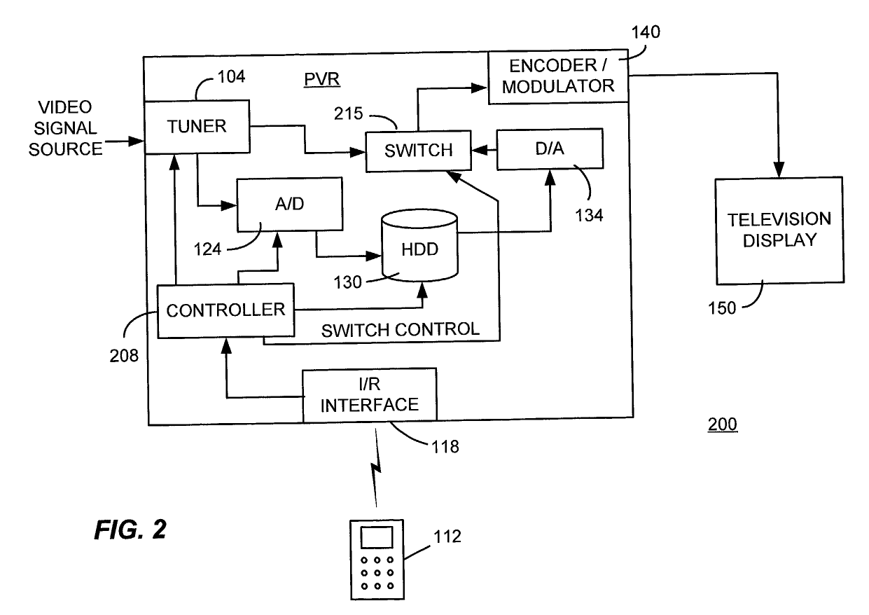

Referring now to FIG. 2, a PVR 200 consistent with an embodiment of the present invention is illustrated in which controller 208 is provided to control the operation of tuner 104, A/D 124, HDD 130 as well as a switching device 215. PVR 200, again, is intended to provide a conceptual view of the operation of PVR 200 and may not accurately depict the actual circuit configuration of a physical PVR. However, the functional representation is believed to be most instructive. Switch 215 provides a signal to encoder/modulator 140 to determine a source for the image ultimately displayed on television display 150. The output may be provided directly from the tuner 104. Alternatively, the output may be provided through D/A 134 after a digitized representation of the input signal is stored in the hard disk drive 130 and subsequently retrieved depending upon a mode of operation of the PVR 200.

In this embodiment of PVR 200, operation can be carried out in a number of ways, depending upon the design objectives. In a first embodiment, operation can be identical to that of PVR 100 with a normal mode of operation being display on television display 150 of a signal only after it has been digitized and then stored on and retrieved from the HDD 130. Thus, in a normal viewing mode, the switch 215 couples the signal from D/A 134 to the modulator 140 (or other output circuit). To improve channel change speed, when controller 208 detects a channel change command from I/R interface 118, the switch 215 is directed by the controller to switch its input source so that it's output to modulator 140 is taken directly from tuner 104, at least for a period of time immediately after the channel is changed. The switch can then be switched back to its previous position whenever a command is issued that uses the PVR 200's hard disk drive 130 for special effect operations such as live pause, reverse, slow motion, instant replay, etc.

In another mode of operation, the PVR 200 can normally operate in a mode that provides for rapid channel change unless a command for a special effect operational mode is received. Thus, according to this embodiment, the switch 215 normally provides “live” video from tuner 104 to modulator 140 for normal television viewing. By way of example, and not limitation, consider the live pause command (as an example of a special effect operation) which simulates the pause effect commonly used in playback of video tapes using a video tape recorder. When a command for live pause is received, the controller 208 directs switch 215 to switch its input to D/A 134 and begin a repeated playback of the current frame (stored in HDD 130 or in a frame buffer) to create a freeze effect during the pause. When the user resumes viewing (e.g., by again pressing a pause button), playback resumes from the HDD 130 starting at the frozen frame. Since the HDD 130 is storing information as it is being received, the viewer can resume viewing at the point where the pause was instituted. Operation continues in this manner until the user changes channels. At this point, the controller 208 commands switch 215 to switch its input to tuner 104 so that a near instantaneous channel change is observed by the viewer.

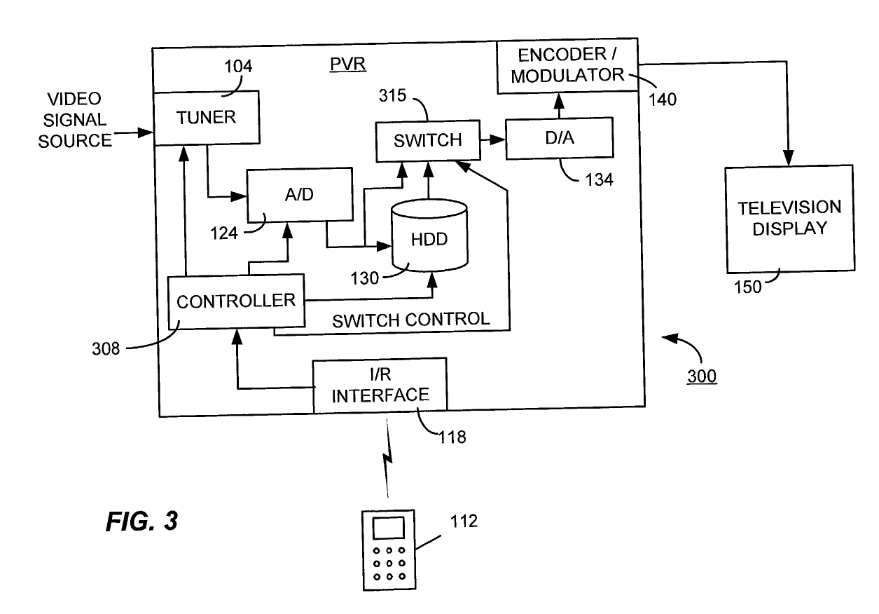

FIG. 3 depicts another embodiment of a PVR 300 consistent with the present invention in which a controller 308 controls a switch 315 that again chooses between a “live” signal and a delayed recorded signal for presentation to the viewer. Operation of this embodiment is similar except that rather than directly switching the analog signals from tuner 104 and D/A 134, the digitized versions of those signals are provided as inputs to switch 315. Thus, switch 315 receives an output from A/D converter 124 and from HDD 130 which can be selected to provide an output that is either approximately live or delayed by storage and retrieval in HDD 130. Otherwise, operation is analogous.

While switch 315 is depicted as a separate switching device, use of the digitized representations of the live or stored video can lend itself to implementation of the equivalent functions within controller 308. In such an embodiment, the output of A/D 124 and HDD 130 may be controlled by placing data on a bus (not shown) for temporary storage in memory forming a part of controller 308 or PVR 300. By selectively addressing the appropriate storage location or register containing data that represents either “live” video or delayed video, the switching function can be implemented without need for an actual switching element 315. Instead, output can be directed by an appropriate processor or processors extracting the desired information from a memory location corresponding to live data from A/D 124 or delayed data from HDD 130. Although not shown, A/D 124 may be switched to receive inputs from multiple input sources in certain embodiments. Other embodiments will occur to those skilled in the art.

TABLE 1 below illustrates the functions described above with the example of the “live pause” function.

TABLE 1

| | | | SOURCE |
|---|---|---|---|
| CURRENT | PREVIOUS | SOURCE OF VIDEO | OF DISK |
| ACTION | ACTION | OUTPUT | DRIVE INPUT |
| power on | don't care | A-disk drive | live video from |
| | | | decoder |
| | | B-live video from | live video from |
| | | decoder | decoder |
| live pause | don't care | frozen frame from disk | live video from |
| | | drive or cache | decoder |
| resume | live pause | video from disk drive or | live video from |
| | | cache starting at frozen | decoder |
| | | frame | |
| change | don't care | live video from decoder | live video from |
| channel | | | decoder |

As shown in TABLE 1, the hard disk drive always receives live video from the decoder to constantly store a predetermined amount (e.g., 30 minutes worth) of live video to disk. When the power comes on, the output to the television can be supplied either from the disk drive (case A) or from live video (case B). When a live pause is initiated, a frame is frozen on the display, e.g. from the disk drive or from a cache memory. When the play is resumed from a live pause, video from the disk drive is supplied as the output starting at the frozen frame. This operation continues until a channel change at which point the switch redirects video to the output directly from the tuner 104 or A/D converter 124, bypassing storage in and retrieval from the HDD 130.

While the “live pause” effect has been described in conjunction with the description above, any of the special effects used in conjunction with hard disk drive functions could have equally well been given as an example of the operation according to embodiments of the present invention.

In accordance with the embodiments of FIGS. 2-3, the PVR can operate in either one of two modes: 1) a delayed video output mode wherein the output from the PVR is supplied from the HDD 130 through a storage and retrieval process, and 2) a live video mode wherein the output from the PVR is supplied from a source without having passed through the storage and retrieval process. Any node of the circuitry used to implement the PVR which can be tapped to obtain an output suitable for providing an output in one of these two modes can be utilized and is considered fully equivalent to the specific block diagram nodes depicted in FIGS. 2-3 without limitation.

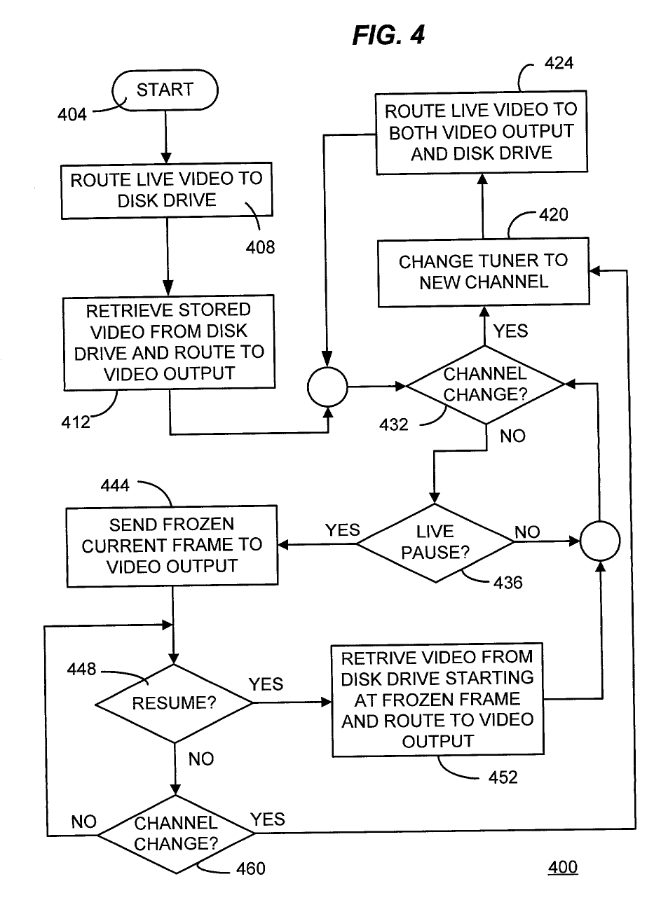

FIG. 4 illustrates an exemplary process 400 of operation of a PVR such as PVR 200 or 300 in which the starting operational mode is that of display of the stored video from HDD 130. Process 400 begins at 404 at power up and/or initialization of the PVR. At 408 newly received live video is sent to the HDD 130 for storage. Stored video is retrieved from HDD 130 at 412 for routing to the display. If a channel change command is received at 432, control passes to 420 where the tuner is set to the new channel. Newly received live video is then routed directly to the video output as well as the disk drive 130 at 424.

Control passes from 424 back to 432 to determine if another channel change is to be made. If so, control returns to 420. If not, a determination is made as to whether a live pause command is to be implemented at 436 (a sequence of such special effect commands can be analyzed at this point also, but live pause is used as an example of the operation). If not, control returns to 432. If so, control passes to 444 where live video continues to be routed to the disk drive and a frozen frame from the disk drive is sent to the output. Live video accumulates on the disk drive 130 until a resume command is received at 448. Control then passes to 452 where delayed video is retrieved from the disk drive starting at the frozen frame to resume viewing while live video continues to be stored on the disk drive. Control then returns to 432.

If no resume command is received at 448, control passes to 460 which determines if a channel change command has been received while in pause mode. If so, control returns to 420. If not, control returns to 448. Similarly, if no channel change command is received at 432, control passes to 436 to determine if a live pause command has been received. If not, control returns to 432. If so, control returns to 444.

Thus, in this illustrative embodiment, the normal mode of operation of the PVR remains that mode wherein output video is supplied from the HDD 130, after any special effect such as live pause is used. Channel changes are sped up by switching the source of the output to bypass the HDD 130 whenever a channel is change command is received.

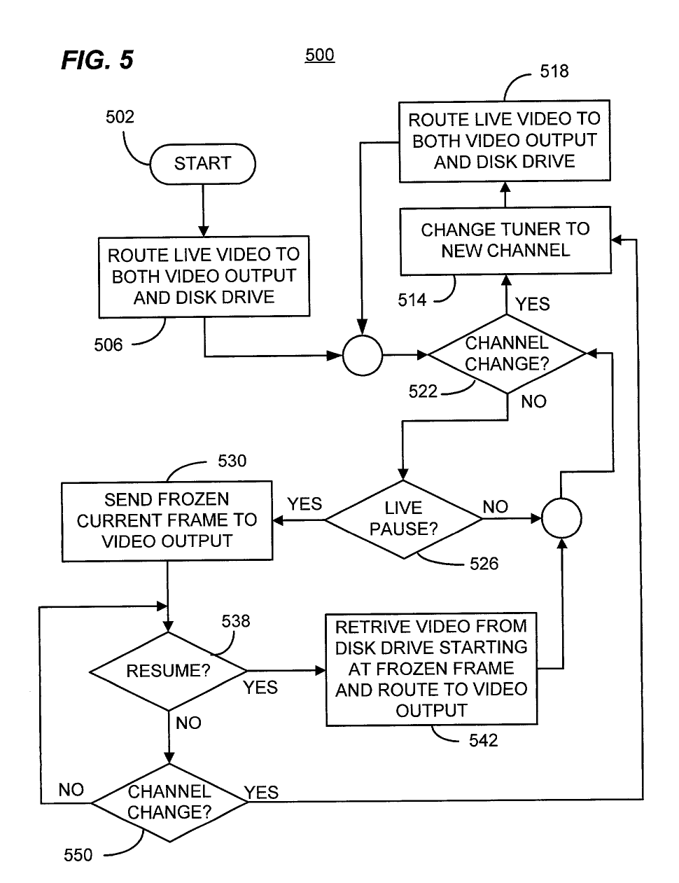

FIG. 5 illustrates another embodiment 500 of a process of operation of an embodiment consistent with the present invention in which the normal mode of operation is to display new video from a source that is live as defined herein in that it bypasses the process of storage to and retrieval from HDD 130. The process starts at 502 with power up and/or initialization of the PVR. At 506, newly received live video is routed to both the video output and the disk drive to provide true live video display on display 150. In the event a channel change command is received at 522, the controller changes the tuner's channel selection at 514 and the newly received live video continues to be routed to both the HDD 130 and the video output of the PVR at 518. Control then returns to 522, and if another channel change command is received, control returns to 514. Otherwise, control passes to 526 to determine if a live pause command has been received. If not, control returns to 522. If so, control passes to 530 where live video continues to be routed to the HDD 130 and a frozen current frame is sent to the output. Control then passes to 538.

When a resume command is received at 538 (e.g., via another activation of a pause button), control passes to 542 where video is retrieved from the disk drive starting at the frozen frame for display while live video continues to be routed to the HDD 130 and is stored for playback delayed by the pause time. Control passes from 546 to 522.

If no resume command is received at 538, control passes to 550 to determine if a channel change command has been received. If not, control passes back to 538. If so, control passes to 514 where the channel change process is implemented. Similarly, if no channel change command is received at 550, control passes to 5538 until a resume command is received.

Thus, in the embodiment 500, normal operation is to view true live video unless a special effect (e.g., live pause) has been instituted requiring output to be taken from the hard disk drive 130. Since the HDD 130 is constantly storing the input video, transition can be made to the HDD 130 as the source of output seamlessly. Any delays incurred here (due to a difference in the time between the time information is stored and retrieved) are generally expected by the user and are not as annoying as such delays when encountered in the channel change process.

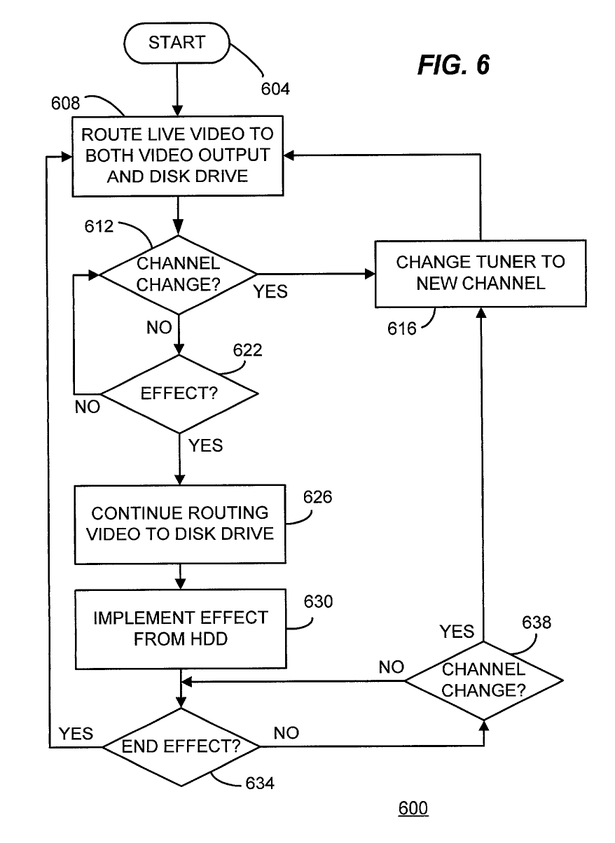

Live pause is used as an example in FIGS. 4-5, but this is not to be limiting. Any of the special features and effects that take advantage of the stored video on HDD 130 can be used as a signal to the controller to switch sources to a delayed version of the video stored on the HDD 130. Similarly, a channel change can be used as a signal to the controller to switch back to an undelayed source of the video signal. This is illustrated in FIG. 6.

FIG. 6 broadly depicts a process 600 in which a special effect that uses output from the HDD 130 is generally used to trigger a transition to selection of output from the HDD 130 and a channel change makes the transition back to operation with true live video as the output. Process 600 starts at 604 with power up and/or initialization of the PVR. At 608, newly received live video is directed to both the HDD 130 and the video output. In the event of a channel change at 612, the tuner's channel selection is changed at 616 and control returns to 608. If no channel change is made at 612, control passes to 622 where it is determined whether a special effect command has been issued that uses the HDD 130 as an output. If not, control returns to 612. If so, control passes to 626 where live video continues to be routed to the HDD 130. The effect is implemented taking the output from the HDD 130 at 630. When the effect is ended at 634, control returns to 608. If a channel change is commanded at 638, control passes to 616.

Thus, a special effect can be used to trigger a change in the source of the signal used for the output with a channel change initiating a change back to true live video as an output of the PVR. Delays in channel changes are avoided to provide a more pleasant experience for the user.

Those skilled in the art will understand that the present examples have assumed use of an RF modulated analog video format such as NTSC and PAL. Thus, in order to change channels, the tuner is switched from a current RF modulating carrier frequency to a new carrier frequency. However, in digital systems such as cable and satellite systems, it is often the case that the several channels are present in a single RF modulated digital transport stream (e.g., a time multiplexed stream of packets). In such an embodiment, the tuner operates to demodulate the RF signal into an IF or baseband signal that is demodulated into a digital transport stream (after any desired signal conditioning) present at the output of the tuner. Thus, in such an environment, a channel change may simply involve selection among several video signals multiplexed within the transport stream in a demultiplexing operation. In other digital scenarios, channel change may involve selection of both a carrier frequency for demodulation as well as selection of a video signal within a transport stream by a demultiplexer.

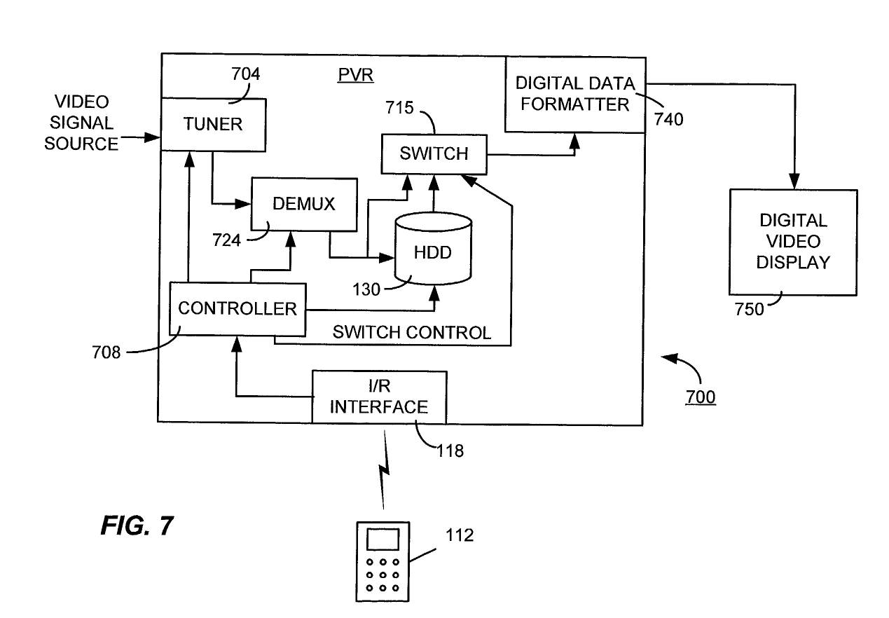

Also, although described in terms of conditioning an output signal for display in an analog display 150 by virtue of conversion of the signal to analog and then modulation of the signal appropriately for display on the display, a digital monitor could also be used which can display video signals based on receipt of digital input of a specified format. These concepts are illustrated in connection with FIG. 7 which illustrates a fully digital embodiment of a PVR 700. Those skilled in the art will appreciate that elements from any of the disclosed embodiments can be combined (e.g., NTSC analog display of digital cable signals) to account for varying systems. In this embodiment, tuner 704 receives a digitally encoded (e.g., MPEG2) RF modulated video signal under the control of controller 708. This signal is demodulated and sent in the form of a digital transport stream to demultiplexer 724. Demultiplexer 724, under control of controller 708 extracts the data associated with a selected channel using PID (packet identifier) filtering and provides the data to HDD 130 as well as switch 715. Switch 715, under control of controller 708 determines which of the live signal from demultiplexer 724 and the delayed signal from HDD 130 is provided to a digital data formatter 740 using criteria as described previously. In the event the digital data is to be reformatted for display, digital data formatter 740 formats the digital data into a format that can be displayed on the digital video display 750. For example, the data may be reformatted into a stream of pixel values in one embodiment, or may be sent as MPEG2 data with associated timing in another. Many equivalent variations consistent with the teachings herein will occur to those skilled in the art without departing from the present invention. For example, the digital data may also be converted to analog at formatter 740 for display as NTSC or PAL data on an analog display. Other variations are also possible.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A personal video recorder device, comprising:
input means receiving a video signal input and producing a live video signal as an output;
a disk drive storing a representation of the live video signal input as it is received by the input means and providing as an output a stored video signal;
output means for providing a video output signal;
switching means for routing a signal to the output means;
control means for controlling the switching means; and
wherein the control means receives user commands and responsive to a user command to change a channel, commands the switching means to route the live video signal to the output means.

2. The apparatus according to claim 1, wherein the input means comprises a tuner.

3. The apparatus according to claim 2, wherein the input means further comprises an analog to digital converter.

4. The apparatus according to claim 2, wherein the input means further comprises a demultiplexer.

5. The apparatus according to claim 1, wherein the output means comprises a modulator.

6. The apparatus according to claim 1, wherein the output means comprises a digital video formatter.

7. The apparatus according to claim 1, wherein the output means provides the output signal formatted as one of NTSC, PAL, DVI and MPEG.

8. The apparatus according to claim 1, wherein the output means further comprises a digital to analog converter receiving the stored video signal and converting the stored video signal to an analog form.

9. The apparatus according to claim 1, wherein the input means comprises a tuner and the output means comprises a modulator, and wherein the live video signal is routed by the switching means from the tuner to the modulator.

10. The apparatus according to claim 1, wherein the input means comprises a tuner and an analog to digital converter;
wherein the output means comprises a digital to analog converter and a modulator; and
wherein the live video signal is routed by the switching means from the analog to digital converter to the digital to analog converter.

11. The apparatus according to claim 1, wherein the input means comprises a tuner and a demultiplexer;
wherein the output means comprises a digital data formatter; and
wherein the live video signal is routed by the switching means from the demultiplexer to the digital data formatter.

12. The apparatus according to claim 1, wherein responsive to a user command to implement an effect using the disk drive, the control means commands the switching means to route the stored video signal to the output means.

13. The apparatus according to claim 12, wherein the effect comprises a live pause effect.

14. A personal video recorder device, comprising:
input means receiving a video signal input and producing a live video signal as an output;
a disk drive storing a representation of the live video signal input as it is received by the input means and providing as an output a stored video signal;
output means for providing a video output signal;
switching means for routing a signal to the output means;
control means for controlling the switching means; and
wherein the control means receives user commands and responsive to a user command to implement an effect using the disk drive, commands the switching means to route the stored video signal to the output means.

15. The apparatus according to claim 14, wherein the input means comprises a tuner.

16. The apparatus according to claim 15, wherein the input means further comprises an analog to digital converter.

17. The apparatus according to claim 15, wherein the input means further comprises a demultiplexer.

18. The apparatus according to claim 14, wherein the output means comprises a modulator.

19. The apparatus according to claim 14, wherein the output means comprises a digital video formatter.

20. The apparatus according to claim 14, wherein the output means provides the output signal formatted as one of NTSC, PAL, DVI and MPEG.

21. The apparatus according to claim 14, wherein the output means further comprises a digital to analog converter receiving the stored video signal and converting the stored video signal to an analog form.

22. The apparatus according to claim 14, wherein the input means comprises a tuner and the output means comprises a modulator, and wherein the live video signal is routed by the switching means from the tuner to the modulator.

23. The apparatus according to claim 14, wherein the input means comprises a tuner and an analog to digital converter;
wherein the output means comprises a digital to analog converter and a modulator; and
wherein the live video signal is routed by the switching means from the analog to digital converter to the digital to analog converter.

24. The apparatus according to claim 14, wherein the input means comprises a tuner and a demultiplexer;
wherein the output means comprises a digital data formatter; and
wherein the live video signal is routed by the switching means from the demultiplexer to the digital data formatter.

25. The apparatus according to claim 14, wherein responsive to a user command to change a channel, the control means commands the switching means to route the live video signal to the output means.

26. The apparatus according to claim 14, wherein the effect comprises a live pause effect.

27. A personal video recorder device, comprising:
a tuner receiving a video signal input and producing a live video signal as an output;
an analog to digital converter receiving the live video signal and converting it to a digital live video signal;
a disk drive receiving and storing the digital live video signal input as it is produced by the analog to digital converter and providing as an output a stored digital video signal;
a digital to analog converter receiving the stored digital video signal and producing an analog video signal;
an output circuit that provides an output signal suitable for display on a video display;
a switch that routes a signal to the output circuit;
a controller that directs the switch to provide one of the live video signal and the analog video signal to the output circuit; and
wherein the controller receives user commands and responsive to a user command to change a channel, commands the switch to route the live video signal to the output circuit.

28. The apparatus according to claim 27, wherein the output circuit comprises a modulator.

29. The apparatus according to claim 27, wherein the output circuit provides the output signal formatted as one of NTSC, PAL, DVI and MPEG.

30. The apparatus according to claim 27, wherein responsive to a user command to implement an effect using the disk drive, the controller commands the switch to route the analog video signal to the output circuit.

31. The apparatus according to claim 30, wherein the effect comprises a live pause effect.

32. A personal video recorder device, comprising:
a tuner receiving a video signal input and producing a live video signal as an output;
an analog to digital converter receiving the live video signal and converting it to a digital live video signal;
a disk drive receiving and storing the digital live video signal input as it is produced by the analog to digital converter and providing as an output a stored digital video signal;
a digital to analog converter receiving the stored digital video signal and producing an analog video signal;
an output circuit that provides an output signal formatted for display on a video display;
a switch that routes a signal to the digital to analog converter;
a controller that directs the switch to provide one of the digital live video signal and the stored digital video signal to the digital to analog converter; and
wherein the controller receives user commands and responsive to a user command to change a channel, commands the switch to route the digital live video signal to the digital to analog converter.

33. The apparatus according to claim 32, wherein the output circuit comprises a modulator.

34. The apparatus according to claim 32, wherein the output circuit provides the output signal formatted as one of NTSC, PAL, DVI and MPEG.

35. The apparatus according to claim 32, wherein responsive to a user command to implement an effect using the disk drive, the controller commands the switch to route the stored digital video signal to the digital to analog converter.

36. The apparatus according to claim 35, wherein the effect comprises a live pause effect.

37. A personal video recorder device, comprising:
a tuner receiving a video signal input and producing a live video signal as an output;
an analog to digital converter receiving the live video signal and converting it to a digital live video signal;
a disk drive receiving and storing the digital live video signal input as it is produced by the analog to digital converter and providing as an output a stored digital video signal;
a digital to analog converter receiving the stored digital video signal and producing an analog video signal;
an output circuit that provides an output signal to a video display;
a switch that routes a signal to the digital to analog converter;
a controller that directs the switch to route one of the digital live video signal and the stored digital video signal to the digital to analog converter; and
wherein the controller receives user commands and responsive to a user command to implement an effect using the disk drive, the controller commands the switch to route the stored digital video signal to the digital to analog converter.

38. The apparatus according to claim 37, wherein the output circuit comprises a modulator.

39. The apparatus according to claim 37, wherein the output circuit provides the output signal formatted as one of NTSC, PAL, DVI and MPEG.

40. The apparatus according to claim 37, wherein responsive to a user command change a channel, the controller commands the switch to route the digital live video signal to the digital to analog converter.

41. The apparatus according to claim 40, wherein the effect comprises a live pause effect.

42. A personal video recorder device, comprising:
input circuit receiving a video signal input and producing a live video signal as an output;
a disk drive storing a representation of the live video signal input as it is received by the input circuit and providing as an output a stored video signal;
an output circuit that provides an output signal suitable for driving a video display;
switching means for routing a signal to the output circuit;
control means for controlling the switching means; and
wherein the control means receives user commands and responsive to a user commands operates the switching means in one of a live video output mode and a delayed video output mode, wherein in the delayed video output mode the switching means routes a signal to the output circuit by retrieval of the stored video signal and wherein in the live video output mode the switching means routes a signal to the output circuit without storage and retrieval in the disk drive.

43. The apparatus according to claim 42, wherein responsive to a command to change a channel, the control means controls the switching means to operate in the live video output mode.

44. The apparatus according to claim 42, wherein responsive to a command to implement an effect using the disk drive, the control means controls the switching means to operate in the delayed video output mode.

45. The apparatus according to claim 44, wherein the effect comprises a live pause effect.

46. A personal video recorder device, comprising:
a tuner receiving a video signal input and producing a video transport stream as an output;
a demultiplexer receiving the transport stream and extracting digital live video signal therefrom;
a disk drive receiving and storing the digital live video signal input from the demultiplexer and providing as an output a stored digital video signal;
an output circuit that provides an output signal suitable for display on a video display;
a switch that routes a signal to the output circuit;
a controller that directs the switch to provide one of the digital live video signal and the stored digital video signal to the output circuit; and
wherein the controller receives user commands and responsive to a user command to change a channel, commands the switch to route the live digital video signal to the output circuit.

47. The apparatus according to claim 46, wherein the output circuit comprises one of a digital data formatter and a modulator.

48. The apparatus according to claim 46, wherein the output circuit provides the output signal formatted as one of NTSC, PAL, DVI and MPEG.

49. The apparatus according to claim 46, wherein responsive to a user command to implement an effect using the disk drive, the controller commands the switch to route the stored digital video signal to the output circuit.

50. A personal video recorder device, comprising:
a tuner receiving a video signal input and producing a video transport stream as an output;
a demultiplexer receiving the transport stream and extracting digital live video signal therefrom;
a disk drive receiving and storing the digital live video signal input from the demultiplexer and providing as an output a stored digital video signal;
an output circuit that provides an output signal suitable for display on a video display;
a switch that routes a signal to the output circuit;
a controller that directs the switch to provide one of the digital live video signal and the stored digital video signal to the output circuit; and
wherein the controller receives user commands and responsive to a user command to implement an effect using the disk drive, the controller commands the switch to route the stored digital video signal to the output circuit.

51. The apparatus according to claim 50, wherein the output circuit comprises one of a digital data formatter and a modulator.

52. The apparatus according to claim 50, wherein the output circuit provides the output signal formatted as one of NTSC, PAL, DVI and MPEG.

53. The apparatus according to claim 50, wherein responsive to a user command to implement an effect using the disk drive, the controller commands the switch to route the stored digital signal to the output circuit.

54. A method of controlling operation of a personal video recorder (PVR), comprising:
receiving an input signal from a video source;
storing a representation of the video signal on a hard disk drive;
providing a video output signal;
controlling a source of the output signal by determining if a channel change command has been issued, wherein:
if a channel change command has not been issued, selecting the source of the output signal to be from the hard disk drive; and
if a channel change command has been issued, selecting the source of the output signal to be from a source prior to the hard disk drive so that the source of the output signal is not delayed by storage to and retrieval from the hard disk drive.

55. The method according to claim 54, further comprising:
controlling a source of the output signal by determining if an effect command has been issued, wherein:
if an effect command has been issued, selecting the source of the output signal to be from the hard disk drive; and
if an effect command has not been issued, selecting the source of the output signal to be from a source prior to the hard disk drive so that the source of the output signal is not delayed by storage to and retrieval from the hard disk drive.

56. The method according to claim 55, wherein the effect comprises a live pause effect.

57. An electronic storage medium storing instructions that when executed on a programmed processor carry out the method according to claim 54.

58. A method of controlling operation of a personal video recorder (PVR), comprising:
receiving an input signal from a video source;
storing a representation of the video signal on a hard disk drive;
providing a video output signal;
controlling a source of the output signal by determining if an effect command has been issued, wherein:
if an effect command has been issued, selecting the source of the output signal to be from the hard disk drive; and
if an effect command has been issued, selecting the source of the output signal to be from a source prior to the hard disk drive so that the source of the output signal is not delayed by storage to and retrieval from the hard disk drive.

59. The method according to claim 58, wherein the effect comprises a live pause effect.

60. An electronic storage medium storing instructions that when executed on a programmed processor carry out the method according to claim 58.

61. A method of controlling operation of a personal video recorder, comprising:
at a tuner, receiving an input signal containing television programming;
storing a digital representation of the television programming to a storage medium;
retrieving the digital representation from the storage medium;
presenting the retrieved digital representation to an output in a format suitable for display on a television display; and
receiving a channel change command, and in response thereto presenting a representation of the television programming received at the tuner to the output without the storing and retrieving.

62. The method according to claim 61, further comprising receiving an effect command, and in response thereto presenting the retrieved digital representation to the output.

63. The method according to claim 62, wherein the effect comprises a live pause effect.

64. An electronic storage medium storing instructions that when executed on a programmed processor carry out the method according to claim 61.

65. A method of controlling operation of a personal video recorder, comprising:
at a tuner, receiving an input signal containing television programming;
storing a digital representation of the television programming to a storage medium;
sending a representation of the input signal to an output formatted for display on a display as live video; and
receiving an effect command, and in response thereto retrieving the digital representation from the storage medium and presenting the retrieved digital representation to the output as delayed video.

66. The method according to claim 65, further comprising receiving a channel change command, and in response thereto presenting a representation of the television programming received at the tuner to the output without the storing and retrieving.

67. The method according to claim 65, wherein the effect comprises a live pause effect.

68. An electronic storage medium storing instructions that when executed on a programmed processor carry out the method according to claim 57.
